(19) United States
(12) Patent Application Publication
(10) Pub. No.: US 2009/0017204 A1
(43) Pub. Date: Jan. 15, 2009

(54) DIE COATER AND DIE COATER ADJUSTMENT METHOD, AS WELL AS METHOD OF MANUFACTURING OPTICAL FILM

(75) Inventors: Makoto KOMATSUBARA, Osaka (JP); Hiroto IGAWA, Osaka (JP); Ryuichi INOUE, Osaka (JP); Mie OTA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/168,362

(22) Filed: Jul. 7, 2008

(30) Foreign Application Priority Data
Jul. 10, 2007 (JP) 2007-180982

(51) Int. Cl. B05D 5/06; B05C 5/00

(52) U.S. Cl. 427/162; 118/300

(57) ABSTRACT

An object of the present invention is to provide a die coater that is capable of applying a coating liquid to a uniform thickness, while employing a relatively simple structure and reducing the frequency of readjustment necessitated due to the change over time. A die coater includes a first block and a second block disposed opposite to each other with a slit formed in a leading end thereof acting as an ejecting port for ejecting a coating liquid, and a shim held between the first block and the second block, in which the width of the slit is adjustable according to the thickness of the shim, and the shim has surfaces in which recessed portions are formed partially in a longitudinal direction of the slit.

### CROSS REFERENCE TO RELATED APPLICATION

This application claims priority from Japanese Patent Application No. 2007-180982, which is incorporated herein by reference.

### BACKGROUND OF THE INVENTION

1. Field of the Invention

The present invention relates to a die coater and a die coater adjustment method, as well as a method of manufacturing an optical film.

2. Discussion of the Background

Conventionally, it is known as one example of a coating apparatus a slit die coater (hereinafter simply referred to a die coater) that has a slit at its leading end as an ejecting port for ejecting a coating liquid. The die coater is generally to coat a coating liquid onto a substrate film by supplying the coating liquid into a manifold formed inside of the die coater, then forcing the coating liquid out to the slit from the manifold, and at the same time moving the substrate film relative to the slit while being held in proximity to the slit.

The thickness of the applied coating liquid, that is, the thickness of the coated film is varied according to the distance between the die coater and the substrate, the slit width of the die coater and the like, and therefore these constitutional elements must be manufactured with high accuracy in order to form a coated film of a uniform thickness.

Especially, when an optical film for use in an image display device, such as a liquid crystal display device, is manufactured, it is necessary to highly accurately adjust the thickness of a coated film to a uniform thickness, since variation in thickness of the coated film may cause adverse influences on the quality of products. Therefore, when such an optical film is to be manufactured by using the aforesaid die coater, it is necessary to highly accurately uniformize the slit width.

As a method for highly accurately adjusting the thickness of a coated film to a uniform thickness, Patent Document 1 as referred below discloses a method which includes roughly processing the constitutional elements of a die coater, then cutting the constitutional elements to remove the remaining stress caused by the rough process, and finishing the constitutional elements by the cutting work. Specifically, the method of the Patent Document 1 is intended to achieve the uniform thickness of a coated film by removing the remaining stress of the constitutional elements while improving the processing accuracy, thereby achieving a uniform slit width.

Meanwhile, Patent Document 2 as referred below discloses a method for adjusting the slit width by providing a recess extending in a longitudinal direction of a slit of a die coater, disposing an adjustment unit in the recess that enables deformation of a head member, thereby deforming the head member.

Patent Document 1: Japanese Patent Application Laid-open No. Hei-11-192452

Patent Document 2: Japanese Patent No. 3501159

However, according to the method of the Patent Document 1, there are problems that a sufficiently uniform thickness of a coated film or a sufficiently uniform slit width is difficult to be obtained for a large-sized die coater, such as those having a coating width or slit length of 1 meter. It is assumed that this is because a large-sized die coater has each constitutional element bent due to its own weight, or parts or members are deformed or twisted when in assembling the constitutional elements together. Thus, these problems are unlikely to be solved only by improving the processing accuracy or removing the remaining stress, as disclosed in the Patent Document 1.

Furthermore, according to the method of the Patent Document 2, there are problems that not only the structure of the die coater becomes complicated and thus its installation is costly, but also the effect of uniformizing the slit width by the adjustment unit is likely to vary over the time, which requires the adjustment work by the adjustment unit for a prolonged time.

In consideration of the above problems, it is an object of the present invention to provide a die coater that is capable of applying a coating liquid to a uniform thickness, while employing a relatively simple structure and reducing the frequency of readjustment necessitated due to the change over time.

### SUMMARY OF THE INVENTION

The present inventors repeated intensive studies in order to solve the above problems, and found that the slit width can be easily adjusted and readjustment is less frequently made than ever before by an arrangement in which a shim extending in the longitudinal direction of a slit is held between the blocks of a die coater, and a recessed portion is formed in the surfaces of the shim by partially polishing the surfaces of the shim in the longitudinal direction of the slit.

Specifically, according to one aspect of the present invention, there is provided a die coater that includes a first block and a second block disposed opposite to each other with a slit formed in a leading end thereof acting as an ejecting port for ejecting a coating liquid, and a shim held between the first block and the second block, in which the width of the slit is adjustable according to the thickness of the shim, and the shim has surfaces in which recessed portions are partially formed in a longitudinal direction of the slit.

According to another aspect of the present invention, there is provided a die coater adjustment method that includes having a shim held between a first block and a second block disposed opposite to each other with a slit formed in a leading end thereof acting as an ejecting port for ejecting a coating liquid, making the width of the slit adjustable according to the thickness of the shim, and forming recessed portions in surfaces of the shim partially in a longitudinal direction of the slit, thereby adjusting the width of the slit in the longitudinal direction of the slit.

According to still another aspect of the present invention, there is provided a die coater adjustment method that includes a provisional assembling step in which a shim is securely held between a first block and a second block that are disposed opposite to each other with a slit formed in a leading end thereof acting as an ejecting port for ejecting a coating liquid, thereby assembling a die coater, a slit width measuring step in which the slit width of the assembled die coater is measured in a longitudinal direction of the slit, a disassembling step in which the die coater is disassembled to have surfaces of the shim exposed to the outside, a polishing step in which the surfaces of the shim are polished based on the measured result of the slit width measured in the slit width measuring step, thereby partially forming recessed portions in the surfaces, and a reassembling step in which the die coater is reassembled by using the polished shim.

According to yet another aspect of the present invention, there is provided a method of manufacturing an optical film that includes forming a resin coated film on a substrate film by using the aforesaid die coater.

According to the present invention, in which recessed portions are formed in the surfaces of the shim in the longitudinal direction of the slit, thereby allowing the width of the slit formed between the blocks with the shim held therebetween to be adjustable in the longitudinal direction, it is possible to form a coated film having a uniform thickness in the width direction (i.e., the longitudinal direction of the slit), while allowing the die coater to have a remarkably simple structure.

According to the present invention, the slit width can be adjusted by adjusting the polishing portion and the polishing amount, of the shim, while compensating even for the non-uniformity of the slit width caused due to the processing accuracy of each material, the assembled state of the parts, or the bending of the parts of the die coater due to their own weights. Therefore, according to the present invention, it is possible to relatively easily adjust the slit width even for a large-sized die coater, such as those having a slit length of 1 meter, and for example, there is an advantage in that the die coater of the present invention is very appropriately used for manufacturing an optical film for use in an image display device.

Furthermore, according to the present invention, there is another advantage in that, since the thickness of the polished shim is not changed over the time, the frequency of readjusting the slit width can be reduced.

### BRIEF DESCRIPTION OF THE DRAWINGS

The above, and other objects, features and advantages of the present invention will become apparent from the detailed description thereof in conjunction with the accompanying drawings wherein.

FIG. 1 is a perspective view illustrating one embodiment of a die coater according to the present invention.

FIG. 2 is an exploded perspective view illustrating the die coater of FIG. 1.

FIG. 3 is a plan view illustrating one embodiment of a shim according to one embodiment of the present invention.

FIG. 4 is a cross sectional view of the shim of FIG. 3 taken along a line IV-IV.

### DETAILED DESCRIPTION OF THE PREFERRED EMBODIMENT

Now, the description will be made for embodiments of the present invention with reference to the drawings attached hereto.

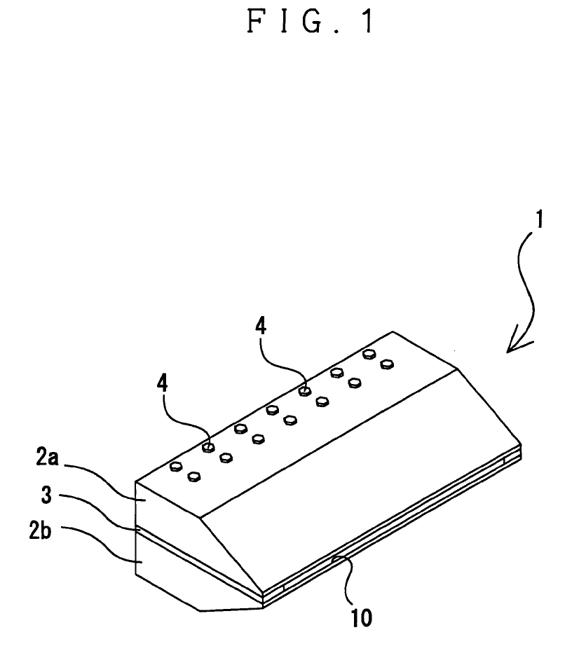

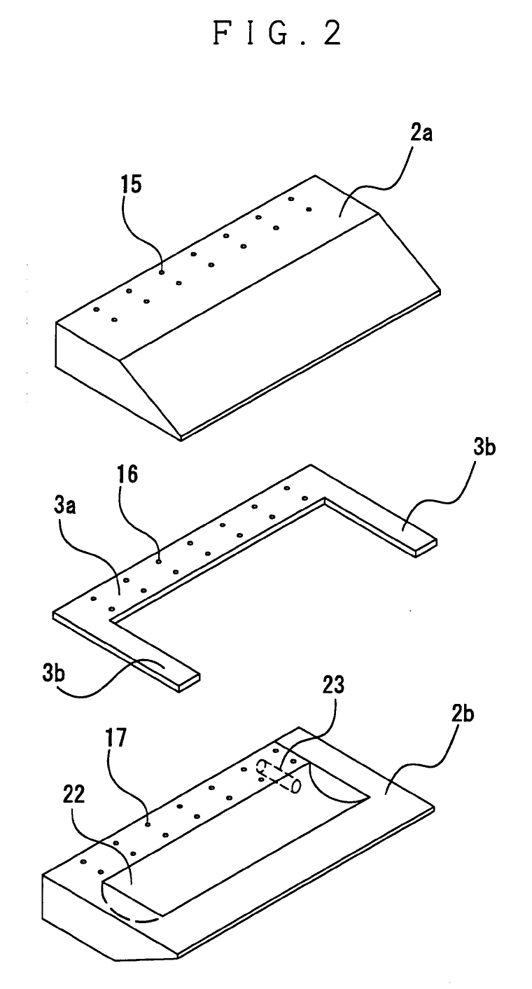

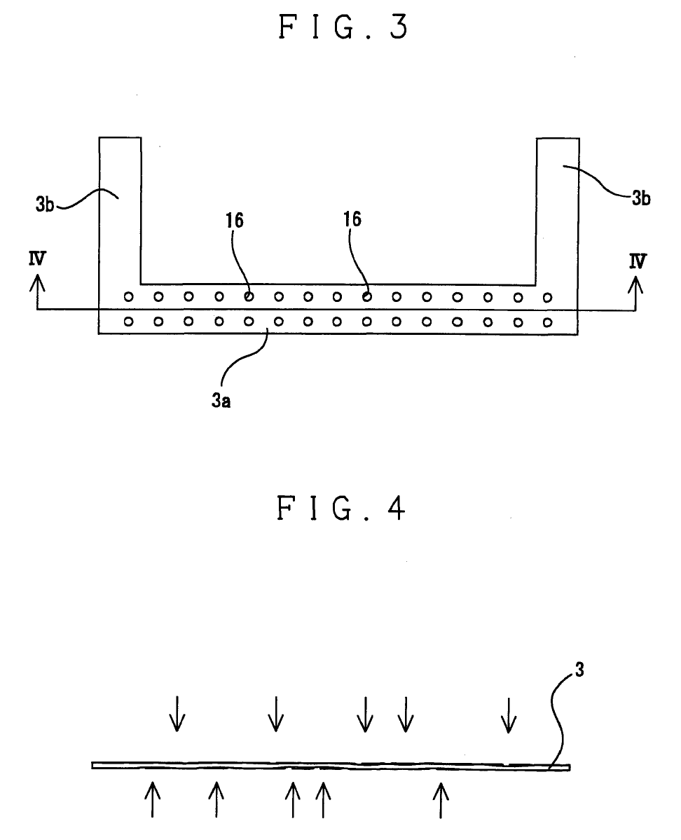

FIG. 1 is a perspective view illustrating one embodiment of the die coater of the present invention, and FIG. 2 is an exploded perspective view of the die coater of FIG. 1.

As illustrated in FIG. 1, a die coater 1 of this embodiment includes a first block 2a and a second block 2b disposed opposite to each other with a slit 10 formed in a leading end thereof acting as an ejecting port for ejecting a coating liquid, and a shim 3 held between the first block 2a and the second block 2b. Bolts 4 are provided as fixing members for fixing the die coater 1 in position with the shim 3 held between the first and second blocks 2a, 2b.

A recess 22 acting as a manifold is formed in the opposite surfaces of the first and second blocks 2a, 2b, and a coating liquid, which has been fed by a pump or the like (not illustrated), is supplied into the recess 22 via a feed port 23.

In this embodiment, the shim 3 has a base end portion 3a having a rectangular shape extending in the longitudinal direction of the slit 10, and a pair of extending portions 3b each having a rectangular shape that extend respectively from the opposite ends of the base end portion at a right angle thereto towards the leading end of a die coater. Thus, the shim 3 as a whole has a U-shape.

The bolts 4 respectively have leading ends passing through through-holes 15 formed in the first block 2a and through-holes 16 formed in the shim 3, and are screwed into threaded holes 17 formed in the second block 2b, so that the first block 2a and the second block 2b are fastened together so as to be held in proximity to each other. The bolts 4 (e.g., 5 to 10 bolts) are aligned in the longitudinal direction of the slit 10, and, in this embodiment, are aligned in two rows in a width direction of the base end portion 3a of the shim 3, as illustrated in FIG. 1.

When the first block 2a and the second block 2b are fastened together with the shim 3 held therebetween, a manifold 22 and a fluid passage extending from the manifold 22 to the slit 10 for a coating liquid are formed inside the die coater 1. Specifically, the fluid passage of the coating liquid is defined by the opposite inner surfaces of the first block 2a and the second block 2b, and the shim 3. The slit 10 having a width equal to the thickness of the shim 3 is formed in the leading end of the fluid passage.

The thickness of the shim 3 is not necessarily limited to a specific thickness, while in this embodiment, the shim 3 has preferably a thickness of 10-500 μm and more preferably a thickness of 50-300 μm, from the viewpoint of the necessity to partially polish the surfaces of the shim 3 in the longitudinal direction of the slit 10 in order to adjust the slit width.

FIG. 4 is a cross sectional view taken along the longitudinal axis of the base end portion 3a of the shim 3, in which recesses formed by polishing are indicated by arrows and illustrated in exaggerated form. As illustrated in FIG. 4, in this embodiment, the base end portion 3a of the shim 3 is polished partially in the longitudinal direction of the slit 10, thereby causing the shim 3 to have opposite surfaces partially recessed or curved inwardly.

The polishing positions and the polishing amounts, of the shim 3 are appropriately adjusted according to the structure, size or mounting angle of the die coater. Specifically, the polishing positions and the polishing amounts, of the shim may be determined based on the measured result obtained through an operation which involves preparing a shim, blocks and the like to have substantially flat surfaces by rough process or finish process, then once provisionally assembling these constitutional elements into a die coater, and then measuring the slit width of the formed die leading end in the longitudinal direction thereof.

The polishing means of the shim 3 is not necessarily limited to a specific means, and, for example, it can be cited, as an example of the polishing means, physically polishing means by water-resistant paper, abrasive compound or the like, or chemically polishing means by etching, electrolytic polishing or the like.

A polishing position of the shim 3 is preferably a position at which a fixing member is mounted, or the base end portion 3a having a rectangular shape in this embodiment, while it is also possible to polish the extending portions 3b according to needs and circumstances. When polishing the base end portion 3a of the shim 3, it is possible to polish the base end portion 3a across its entire width, or polish only any one of the lateral sides of the base end portion 3a with the longitudinal axis therebetween (i.e., a fluid passage side or a side opposite to the fluid passage). Alternatively, the polishing may be made by combining these polishing manners.

When polishing the surfaces of the base end portion 3a of the shim, a slightly recessed portions are formed according to the amount of polishing, and therefore by bringing the shim 3 having these recessed portions into abutting engagement with the first and second blocks 2a, 2b, these blocks 2a, 2b are deformed according to the polishing position and the polishing amount, of the shim, that is, according to the position and the shape, of the recessed portion, so that the slit width is adjusted.

This embodiment was described by taking, for example, the die coater in which the inner surfaces of the first block 2a and the second block 2b are formed into flat surfaces without stepped portions, and the thickness of the shim 3 is adjusted to be equal in dimension to the width of the slit 10. The present invention is not necessarily limited to this embodiment. Specifically, the die coater may be structured so that any one or both of the inner surfaces of the first block 2a and the second block 2b may be provided with a stepped portion and the thickness of the shim is not equal in dimension to the slit width.

Now, the description will be made for an embodiment of a die coater adjustment method when the die coater 1 having the above structure is employed.

A die coater adjustment method of this embodiment includes a provisional assembling step in which the shim 3 is held between the first block 2a and the second block 2b and they are fixed together by the bolts 4, thereby assembling the die coater 1, a slit width measuring step in which the slit width of the assembled die coater 1 is measured in the longitudinal direction of the slit, a disassembling step in which the die coater 1 is disassembled to have the surfaces of the shim 3 exposed to the outside, a polishing step in which the surfaces of the shim 3 are polished based on the measured result of the slit width measured in the slit width measuring step, and an assembling step in which the die coater 1 is reassembled by using the polished shim 3.

When the slit width is measured in the slit width measuring step, it is preferable to measure the slit width with the die coater actually mounted to a coating apparatus, or with the die coater tilted at an angle equal to its mounting angle. When the die coater 1 is tilted, the shape of the slit 10 may also be slightly changed due to the weight of the blocks of the die coater 1. Therefore, when the die coater is actually mounted to a coating apparatus, or is tilted at an angle equal to the mounting angle of the die coater, it is possible to uniformly adjust the slit width while compensating for its deformation due to the weight of the blocks.

In the present invention, according to needs and circumstances, after assembling the die coater in the assembling step, a series of steps, namely the slit width measuring step, the dissembling step, the polishing step and the assembling step may be repeated, thereby making it possible to enhance the accuracy of the slit width.

Another embodiment of a manufacturing method of an optical film according to the present invention involves forming a resin coated film on a substrate film by using the die coater 1 having the aforesaid structure.

While no specific limitation is applied to the material of the substrate film, it may be appropriately selected according to the intended use. Specifically, for an optical use, it is preferable to use a film of transparent polymer, such as polyester polymer, such as polyethylene terephthalate and polyethylene naphthalate; cellulose polymer, such as diacetyl cellulose and triacetyl cellulose; acrylic polymer, such as polycarbonate polymer and polymethyl methacrylate; styrene polymers, such as polystyrene and acrylonitrile-styrene copolymers; olefin polymer, such as polyethylene, polypropylene, polyolefin having a cyclo or norbornene structure and ethylene propylene copolymers; vinyl chloride polymer; and amide polymer, such as Nylon and aromatic polyamide.

Furthermore, it can be cited, as a material of a film of transparent polymer, imide polymer; sulfone polymer; polyether-sulfone polymer; polyether-ether-ketone polymer; polyphenylene sulfide polymer; vinyl alcohol polymer; vinylidene chloride polymer; vinyl butyral polymer; allylate polymer; polyoxymethylene polymer; epoxy polymer; and blends of these polymers.

While no specific limitation is applied to the resin of the resin coating liquid, it can be cited, as an example of the resin for the optical use, polymer, such as polyamide, polyimide, polyester, polyetherketone, polyamide-imide or polyester-imide. These polymers may be used solely or as a mixture of two or more polymers having different functional groups, for example, a mixture of polyetherketone and polyamide.

Various types of solvent can be used as a solvent for dissolving the aforesaid resin and can be selected according to the material of each of the resin and the film used, as long as they are capable of dissolving the resin material and are unlikely to erode the film. Specifically, it is possible to use halogenated hydrocarbons, such as chloroform, dichloromethane, carbon tetrachloride, dichloroethane, tetrachloroethane, trichloroethylene, tetrachloroethylene, chlorobenzene, and ortho-dichlorobenzene; phenols, such as phenol and parachlorophenol; aromatic hydrocarbons, such as benzene, toluene, xylene, methoxybenzen, and 1,2-dimethoxybenzene; acetone; ethylacetate; t-butylalcohol; glycerin; ethyleneglycol; triethyleneglycol; ethylene glycolmonomethylether; diethyleneglycoldimethylether; propylene glycol; dipropylene glycol; 2-methyl-2,4-pentanediol; ethylcellosolve; butylcellosolve; 2-pyrolidone; N-methyl-2-pyrolidone; pyridine; triethylamine; dimethylformamide; dimethylacetoamide; acetonitrile; butyronitrile; methyl isobutyl ketone; methyl ethyl ketone; cyclopentanone; and carbon disulfide. These solvents may be used solely or in combination of two or more thereof according to needs and circumstances.

An optical film manufactured by the above method is appropriately used in an image display device, such as a liquid crystal display, and more specifically is very appropriately used as an optical film, in which an optical compensation layer, a hard coat layer, an antireflection layer, a retardation layer and any other optical functional layer are formed by the aforesaid coated film.

The optical film is manufactured by using the die coater having a highly uniform slit width, as mentioned above, and therefore the coated film as formed, that is, an optical functional layer has a highly uniform thickness.

This specification is by no means intended to restrict the present invention to the preferred embodiments set forth therein. Various modifications to the die coater and the die coater adjustment method, as well as the method of manufacturing optical film, as described herein, may be made by those skilled in the art without departing from the spirit and scope of the present invention as defined in the appended claims.

What is claimed is:

1. A die coater comprising a first block and a second block disposed opposite to each other with a slit formed in a leading end thereof acting as an ejecting port for ejecting a coating liquid, and a shim held between the first block and the second block, wherein the width of the slit is adjustable according to the thickness of the shim, and the shim has surfaces in which recessed portions are formed partially in a longitudinal direction of the slit.

2. A die coater adjustment method comprising having a shim held between a first block and a second block disposed opposite to each other with a slit formed in a leading end thereof acting as an ejecting port for ejecting a coating liquid, making the width of the slit adjustable according to the thickness of the shim, and forming recessed portions in surfaces of the shim partially in a longitudinal direction of the slit, thereby adjusting the width of the slit in the longitudinal direction of the slit.

3. A die coater adjustment method comprising a provisional assembling step in which a shim is securely held between a first block and a second block that are disposed opposite to each other with a slit formed in a leading end thereof acting as an ejecting port for ejecting a coating liquid, thereby assembling a die coater, a slit width measuring step in which the slit width of the assembled die coater is measured in a longitudinal direction of the slit, a disassembling step in which the die coater is disassembled to have surfaces of the shim exposed to the outside, a polishing step in which the surfaces of the shim are polished based on the measured result of the slit width measured in the slit width measuring step, thereby partially forming recessed portions in the surfaces, and a reassembling step in which the die coater is reassembled by using the polished shim.

4. A method of manufacturing an optical film comprising forming a resin coated film on a substrate film by using the die coater of claim 1.
